(19) United States
(12) Patent Application Publication
(10) Pub. No.: US 2025/0165771 A1
(43) Pub. Date: May 22, 2025

(54) DEPLOYING TASK-SPECIFIC MACHINE LEARNING MODELS USING SYNTHETIC WEIGHTS

(71) Applicant: SAP SE, Walldorf (DE)

(72) Inventors: Srinivasa Reddy Challa, Guntur (IN); Shashank Mohan Jain, Karnataka (IN)

(21) Appl. No.: 18/515,512

(22) Filed: Nov. 21, 2023

(51) Int. Cl. G06N 3/08; G06N 3/0455

(52) U.S. Cl. CPC G06N 3/08; G06N 3/0455

(57) ABSTRACT

Methods, systems, and computer-readable storage media for providing a ML model using a set of training data, the ML model having a set of weights associated therewith, generating a latent representation of the set of weights by inputting the set of weights into an encoder of a VAE, generating a denoised latent representation based on conditioning text by diffusing the latent representation to generate a noisy latent representation and denoising the noisy latent representation to provide the denoised latent representation, providing a reconstructed set of weights by inputting the denoised latent representation into a decoder of the VAE, the decoder outputting the reconstructed set of weights, and deploying an updated ML model for production inference.

### BACKGROUND

Enterprises continuously seek to improve and gain efficiencies in their operations. To this end, enterprises employ software systems to support execution of operations. Enterprises have embarked on the journey of so-called intelligent enterprise, which includes automating tasks executed in support of enterprise operations using machine learning (ML) systems. For example, one or more ML models are each trained to perform tasks based on training data. Example tasks can include making predictions (inferences) and executing workflows that are responsive to the predictions.

### SUMMARY

Implementations of the present disclosure are directed to deploying machine learning (ML) models for inference in production environments. More particularly, implementations of the present disclosure are directed to provisioning ML models using synthetic weights and deployment of the ML models for inference in production environments.

In some implementations, actions include providing a ML model using a set of training data, the ML model having a set of weights associated therewith, generating a latent representation of the set of weights by inputting the set of weights into an encoder of a variable autoencoder (VAE), generating a denoised latent representation based on conditioning text by diffusing the latent representation to generate a noisy latent representation and denoising the noisy latent representation to provide the denoised latent representation, providing a reconstructed set of weights by inputting the denoised latent representation into a decoder of the VAE, the decoder outputting the reconstructed set of weights, and deploying an updated ML model for production inference. Other implementations of this aspect include corresponding systems, apparatus, and computer programs, configured to perform the actions of the methods, encoded on computer storage devices.

These and other implementations can each optionally include one or more of the following features: the set of weights is provided as a weight matrix including weights that are generated for the ML model during training of the ML model; a dimension of the latent representation is less than a dimension of the set of weights; the conditioning text includes a textual description of a condition that is one of absent from and underrepresented in the training data; the condition includes one or more events associated with timeseries data, the one or more events comprising one or more of a spike and a cycle; deploying the ML model includes transmitting the ML model to a production environment to receive timeseries data and generate inferences responsive to the timeseries data; and the ML model is a long short-term memory autoencoder (LSTM-AE).

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example machine learning (ML) model deployment architecture in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to deploying machine learning (ML) models for inference in production environments. More particularly, implementations of the present disclosure are directed to provisioning ML models using synthetic weights and deployment of the ML models for inference in production environments.

Implementations can include actions of providing a ML model using a set of training data, the ML model having a set of weights associated therewith, generating a latent representation of the set of weights by inputting the set of weights into an encoder of a variable autoencoder (VAE), generating a denoised latent representation based on conditioning text by diffusing the latent representation to generate a noisy latent representation and denoising the noisy latent representation to provide the denoised latent representation, providing a reconstructed set of weights by inputting the denoised latent representation into a decoder of the VAE, the decoder outputting the reconstructed set of weights, and deploying an updated ML model for production inference.

Generating and deploying ML models for inference in production environments is a non-trivial task and suffers from multiple technical challenges. For example, use cases can require ML models to be tailored to specific tasks. Existing approaches for ML model generation and adaptation frequently use fine-tuning of a pre-trained ML model on data representative of a new task. A new task can be described as a task that was not represented or is underrepresented in the original training data used to train the ML model. Such fine-tuning, however, is computationally expensive and often fails to fully adapt the ML model to the new task. That is, computing resources are wasted in producing an under-performing ML model. As another example, ML models can be used to detect occurrences of anomalies. However, by definition, anomalies are rare, non-normal occurrences. Consequently, historical data that is representative of anomalies is sparse. That is, anomalies are underrepresented in the historical data, if at all. This can be referred to as a cold-start problem for ML models, in which there is insufficient training data to train a robust, accurate ML model that is capable of predicting occurrences of anomalies.

In view of the above context, implementations of the present disclosure are directed to provisioning ML models using synthetic weights and deployment of the ML models for inference in production environments. As described in further detail herein, implementations of the present disclosure generate synthetic weights for a ML model, the synthetic weights being tailored to one or more specific tasks that the ML model is to be deployed for. The synthetic weights replace original weights determined for the ML model during training. In some examples, the synthetic weights can be used for generative novel timeseries data as per specified learning captured in the synthetic weights.

In further detail, a ML model is trained, which results in a weight matrix. In some examples, the ML model is provided as a long short-term memory autoencoder (LSTM-AE). In general, an AE can be described as a self-supervised learning ML model that can learn a compressed representation of input data, and a LSTM-AE can be described as an implementation of an AE that can learn a compressed representation of sequence data (e.g., video, text, audio, timeseries). The weight matrix is processed by a variational autoencoder (VAE), which generates a latent representation of the weight matrix. In general, a VAE can be described as a probabilistic ML model that provides latent, low-dimensional representations of an input, here, a weight matrix of a ML model. In some implementations, the latent representation is processed using diffusion and denoising processes based on conditioning text to provide a denoised latent representation. In some examples, the denoised latent representation is further processed by the VAE, which outputs synthetic weights provided in a synthetic weight matrix. The synthetic weight matrix replaces the original weight matrix in the ML model to provide a task-specific ML model (e.g., task-specific LSTM-AE) that is deployed to a production environment for inference.

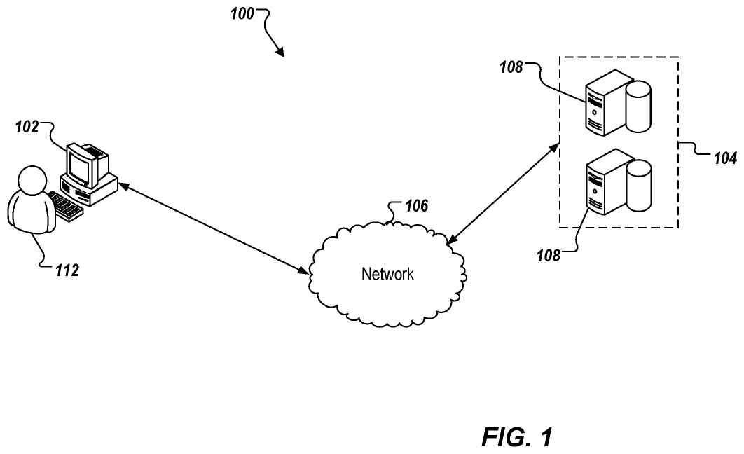

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a ML generation and deployment platform for provisioning of ML models for production inference. As described in further detail herein, the ML generation and deployment platform generates synthetic weights for a (trained) ML model and replaces the (original) weights of the ML model with the synthetic weights to provide a task-specific ML model. In some examples, a VAE is used to generate latent representations of the weights, which are processed through diffusion and denoising processes on conditioning text. The task-specific ML model is deployed to a production environment for inference. In some examples, the production environment can be hosted by the server system 104.

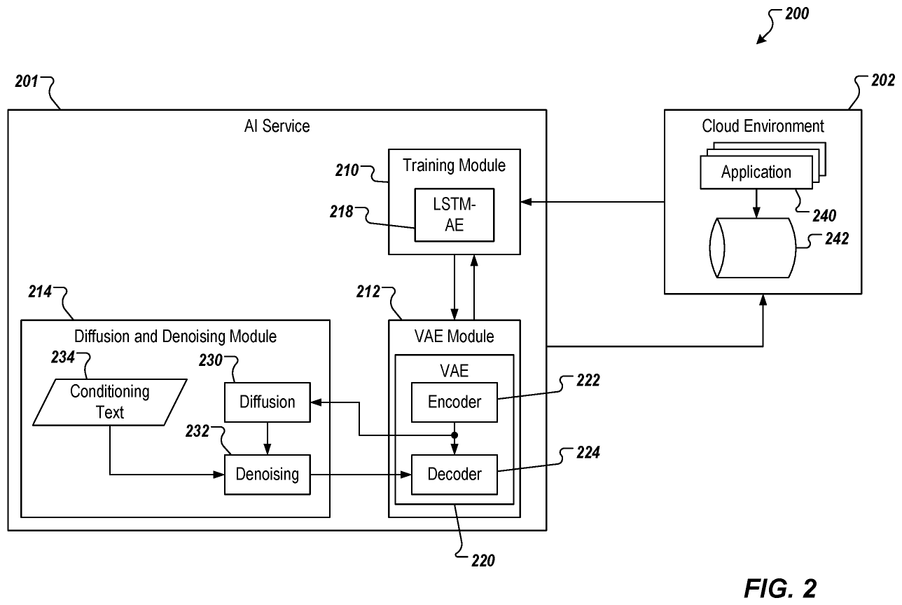

FIG. 2 depicts an example ML model deployment architecture 200 in accordance with implementations of the present disclosure. In the depicted example, the architecture 200 includes an artificial intelligence (AI) service 201 and a cloud environment 202. As described in further detail herein, the AI service 201 generates a task-specific ML model that is deployed to the cloud environment 202 for inference. An example AI service 201 includes, without limitation, SAP AI Core provided by SAP AG of Walldorf, Germany. SAP AI Core can be described as a service in the SAP Business Technology Platform and is designed to handle the execution and operations of AI assets (e.g., ML models) in a standardized, scalable, and hyperscaler-agnostic way. An example cloud environment 202 includes, without limitation, Cloud Foundry provided by Cloud Foundry Inc.

In the example of FIG. 2, the AI service 201 includes a training module 210, a VAE module 212, and a diffusion and denoising module 214. As described in further detail herein, the training module 210 trains a ML model 218. In the example of FIG. 2, the ML model 218 is provided as a LSTM-AE. After training of the ML model 218, the VAE module 212 processes a weight matrix of the (trained) ML model through a VAE 220, which includes an encoder 222 and a decoder 224. As described in further detail herein, the VAE 222 generates a latent representation of the weight matrix, which is processed by the diffusion and denoising module 214 to provide a denoised latent representation. The diffusion and denoising module 214 includes a diffusion sub-module 230 and a denoising sub-module 232. As described in further detail herein, denoising is performed using conditioning text 234.

The cloud environment 202 executes one or more applications 240 that generate and/or receive (e.g., from sensors) timeseries data, which is stored in a datastore 242. An example application 240 can include a predictive maintenance application that provides timeseries data for storage in the datastore 242.

In further detail, the training module 210 trains the ML model 218 on timeseries data provided from the datastore 242. In some examples, the training module 210 pre-processes the timeseries data to provide training data therefrom, and trains the ML model 218 using the training data. In general, ML models are iteratively trained, where, during an iteration, one or more parameters of a model are adjusted, and an output is generated based on the training data. For each iteration, a loss value is determined based on a loss function. The loss value represents a degree of accuracy of the output of the model for the respective iteration. The loss value can be described as a representation of a degree of difference between the input to the model and the expected output of the model. In some examples, if the loss value does not meet an expected value (e.g., is not equal to zero), parameters of the model are adjusted in another iteration of training. In some instances, this process is repeated until the loss value meets the expected value or a number of epochs (iterations) of training have been performed.

Training of the ML model 218 results in a weight matrix that is learned from the training data. In some examples, the weight matrix is populated with weights for a LSTM layer of the ML model 218. An example weight matrix (WGHT) can be provided as:

$$WGHT = [ \begin{matrix}{W}_{f} & {U}_{f} & {b}_{f} \\ {W}_{i} & {U}_{i} & {b}_{i} \\ {W}_{o} & {U}_{o} & {b}_{o} \\ {W}_{c} & {U}_{c} & {b}_{c}\end{matrix} ]$$

Here, W_{f}, U_{f}, b_{f} represent weights for a forget gate, Wᵢ, Uᵢ, bᵢ represent weights for an input gate, Wₒ, Uₒ, bₒ represent weights for an output gate, and W_{c}, U_{c}, b_{c} represent weights for a cell state. The weights W_{f}, Wᵢ, Wₒ, W_{c} are applied to a first input to the LSTM (e.g., xₜ, where t is a current timestep), the weights U_{f}, Uᵢ, Uₒ, U_{c} are applied to a second input to the LSTM (e.g., hₜ₋₁, where t−1 is a previous timestep), and the weights b_{f}, bᵢ, bₒ, b_{c} are biases that are applied.

The weight matrix has a dimensionality that is dependent on dimensions of the input (xₜ) to the LSTM (INP_{DIM}) and dimensions of the output (oₜ) of the LSTM (OUT_{DIM}). In some examples, the size of the weight matrix (S_{WGHT}) is calculated based on the following example relationship:

$${S}_{WGHT} = 4 ( {INP}_{DIM} \times {OUT}_{DIM} ) + 4 ( {OUT}_{DIM}^{2} ) + 4 ( {INP}_{DIM} )$$

For example, for an input of [80×1] and an output of [12×1], where W_{f}, Wᵢ, Wₒ, W_{c} each have dimensions of [12×80], U_{f}, Uᵢ, Uₒ, U_{c} each have dimensions of [12×12], and b_{f}, bᵢ, bₒ, b_{c} each have dimensions of [12×1], S_{WGHT} is calculated to be 4,464.

In accordance with implementations of the present disclosure, after training of the ML model 218, the weight matrix is processed through the VAE 220 by the VAE module 212. In some implementations, the VAE 220 is trained on weight matrices of a set of ML models. In some examples, the matrices are all of same size. Training of the VAE 220 enables its parameters to represent different time series patterns.

In some examples, the encoder 222 maps input data to a set of latent variables in latent space and the decoder 224 maps the latent variables back to the input space. The encoder 222 and decoder 224 are both neural networks that are trained jointly. The VAE 220 is trained to minimize a loss function that includes a reconstruction loss and a KL divergence loss. The reconstruction loss measures the difference between the input weight matrices and the reconstructed weight matrices, and the KL divergence loss measures the difference between the distribution of the latent variables and a prior distribution (e.g., a standard normal distribution). By training the VAE 220 on the weight matrices of pre-existing ML models, the VAE 220 learns a latent representation of these weight matrices. The latent representation can be describes as a mapping of latent variables in latent space that captures the essential features of the weight matrices, which are relevant for the performance of the pre-existing ML models.

In accordance with implementations of the present disclosure, the encoder 222 of the VAE 220 processes the weight matrix to generate a latent representation of the weight matrix. The latent representation is input to the diffusion and denoising module 214, which generates a denoised latent representation.

In further detail, the diffusion sub-module 230 receives the latent representation output by the encoder 222 and executes a diffusion process on the latent representation. The diffusion process can be described as a type of stochastic process that involves a random walk in the latent space to generate new latent variables. In accordance with implementations of the present disclosure, the diffusion process is conditioned on the conditioning text 234, which describes a specific task for which the new ML model is intended. That is, the specific task that the task-specific ML model is to be deployed to production for. Here, the direction and length of the random walk are determined by the conditioning text 234. The diffusion process is trained to generate latent variables that, when decoded by the VAE, produce weight matrices that match the conditioning text. This is done by using a reinforcement learning approach, where the reward is based on how well the generated weight matrices match the conditioning text 234. In some examples, the conditioning text 234 can describe characteristics of a timeseries, such as having monthly cycles only, or with a linear trend and a weekly cycle.

In general, diffusion includes multiple phases. In a first phase, noise is systematically injected the latents using a scheduled process. This scheduled process enables injection of multiple noisy samples of different noise levels and is performed until the latents are complete noise. In a second phase, the noisy latents are denoised conditioned with text (e.g., the conditioning text 234). This can be thought of as a guidance to a network through the text to generate a specific type of latent (corresponding to a certain pattern). By conditioning on text, the search space is reduced and is migrated in a desired direction. In the context of the present disclosure, examples conditioning text can include “generate time series data that has spikes,” and “generate time series data which has monthly seasonality.”

In some examples, text conditioning is implemented by encoding the conditioning text 234 into a text embedding (i.e., a numerical vector). This can be achieved using any appropriate method, such as term frequency inverse document frequency (TF-IDF), word embeddings, and a transformer encoder. The text vector is fed into the diffusion process.

In some examples, the diffusion process is performed over a number of iterations (n), each iteration adding noise. As such, the diffusion process results in a noisy latent representation, which is input to the denoising sub-module 232. In some examples, the denoising sub-module 232 executes a denoising process to denoise the noisy latent representation and provide a denoised latent representation. The denoising process can be described as a reverse diffusion process. In accordance with implementations of the present disclosure, the denoising process is conditioned on the conditioning text 234.

In accordance with implementations of the present disclosure, the denoised latent representation is fed back into the VAE 220, where the decoder 224 generates reconstructed weights (WGHT_{REC}) from the denoised latent representation. The weights of the ML model 218 are updated based on a difference between the original input data and the reconstructed data, thereby improving the ability of the ML model 218 to accurately reconstruct the original data from the latent representation. In some examples, the reconstructed weights replace the original weights (e.g., WGHT_{REC} replaces WGHT) in the ML model 218. This iterative process of encoding, diffusing, denoising, and decoding continues until the ML model 218 is adequately trained.

Implementations of the present disclosure achieve one or more technical improvements. For example, implementations of the present disclosure enable provisioning of task-specific ML models in a resource-efficient manner. In some examples, the weight matrix of the ML model 218 has a relatively high dimension, while the latent representation provided by the encoder 222 of the VAE 220 is relatively low dimension. Here, computational efficiencies are achieved, because the diffusion and denoising module 214 is processing the low-dimensional latent representation instead of high-dimensional weight matrix. Computational efficiencies are also achieved beforehand in training of models using in the diffusion and denoising module 214, because training is performed using low-dimensional latent representations as training data instead of high-dimensional weight matrices as training data. As another example, implementations of the present disclosure resolve the cold start problem to provision task-specific ML models in instances where there as an absence or an underrepresentation of data in the training data (e.g., absence or underrepresentation of anomalies in the training data). For example, implementations of the present disclosure avoid use of resource-inefficient techniques, such as fine-tuning of existing ML models, which anyway result in inaccurate ML models for specific tasks.

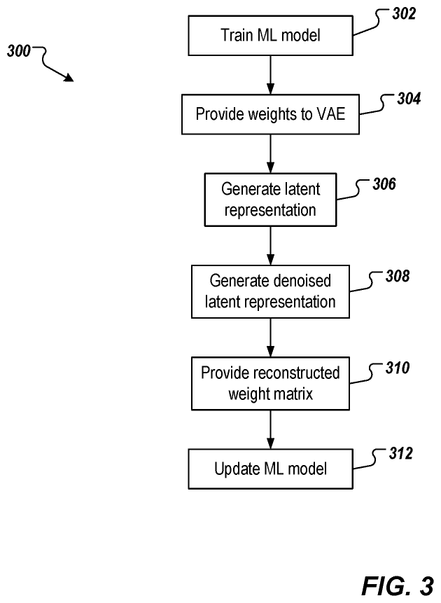

FIG. 3 depicts an example process 300 that can be executed in accordance with implementations of the present disclosure. In some examples, the example process 300 is provided using one or more computer-executable programs executed by one or more computing devices.

A ML model is trained (302). For example, and as described herein, the ML model 218 (e.g., LSTM-AE) of FIG. 2 is trained using training data provided from the datastore 242. Training of the ML model 218 results in a weight matrix (e.g., WGHT). Weights are provided to a VAE (304). For example, and as described herein, the weight matrix of the ML model 218 is provided as input to the VAE 220 executed by the VAE module 212. A latent representation is generated (306). For example, and as described herein, the encoder 222 of the VAE 220 processes the weight matrix to generate a latent representation of the weight matrix. Here, the latent representation is of a lower dimension than the weight matrix.

A denoised latent representation is generated (308). For example, and as described herein, the latent representation is processed through the diffusion and denoising module 214, which diffuses (introduces noise into) the latent representation to provide a noisy latent representation, and denoises (reverse diffusion, removing noise from) the noisy latent representation to provide the denoised latent representation. In accordance with implementations of the present disclosure, the conditioning text 234 is used to steer provisioning of the denoised latent representation. Reconstructed weights are provided (310). For example, and as described herein, the denoised latent representation is processed by the decoder 224 of the VAE 220, which provides a reconstructed weight matrix as output. The ML model is updated (312). For example, and as described herein, weights of the ML model 218 are updated based on the reconstructed weight matrix.

Implementations of the present disclosure can be realized in one or more use cases. For example, predictive maintenance is an example use case and can include one or more applications that receive timeseries data representative of a condition and/or state of an entity and/or of an environment that the entity operates within. One or more ML models can be used to predict occurrences that can require maintenance to be performed on the entity to avoid and/or mitigate an adverse condition (e.g., the entity being unavailable for an extended period of time). Implementations of the present disclosure enable provisioning and deployment of a task-specific ML model to detect anomalous conditions in the predictive maintenance context, where training data used to initial train the ML model is absent of or underrepresents, such anomalous conditions.

To illustrate implementations of the present disclosure, a non-limiting, example use case is described in further detail, which includes an application programming interface (API) management system. An example API management system includes SAP APIM provided by SAP SE of Walldorf, Germany. The job of the API management system is to proxy calls to target API endpoints and apply various policies (e.g., security, rate limiting) on top of the API calls. Customers of the API management system demand to understand whether the usage of their APIs is normal or whether there are abnormal patterns or anomalies can be seen in the usage. This enables customers to perform actions to mitigate, such as applying scaling of the target systems or applying filters for a specific set of users who might be maliciously targeting the system. These abnormal patterns are hard to detect, as they do not occur that often. For this reason, an anomaly detection system has to be shown a lot of normal data, so that it is robust to outlier detection. However, a cold-start problem is present in that there is insufficient data to train the anomaly detection systems. Implementations of the present disclosure address this issue through provisioning of synthetic weights and generation of diverse data, which is a variation of original data. This enables the ML models to be generalized to increasing variations.

In further detail, and with reference to FIG. 2, API call data is provided as input to the VAE 220. Synthetic weights of the VAE 220 are pulled from a datastore, and include synthetic weights that has been previously generated for the API call data. The synthetic weights capture variations in the time series of API calls recorded in the API call data. In using the synthetic weights on original time series of the API call data, variations of the same time series data of the API call data are generated. That is, variation API call data can be generated.

In the example use case, the ML model 218 (LSTM AE) can be trained using the API call data and the variation API call data. This makes the network more generalizable and can detect variations in incoming API data during inference. During inference, when the ML model 218 receives API call data that represents a normal scenario (e.g., non-anomalous), the ML model 218 is able to successfully reconstruct the input, which also includes variations learned using the synthetic weights. Here, the reconstruction error is sufficiently small that no anomaly is detected. However, if the ML model 218 receives API data that represents an anomalous scenario (e.g., irregular use of APIs), the reconstruction error is sufficiently large that an anomaly is detected.

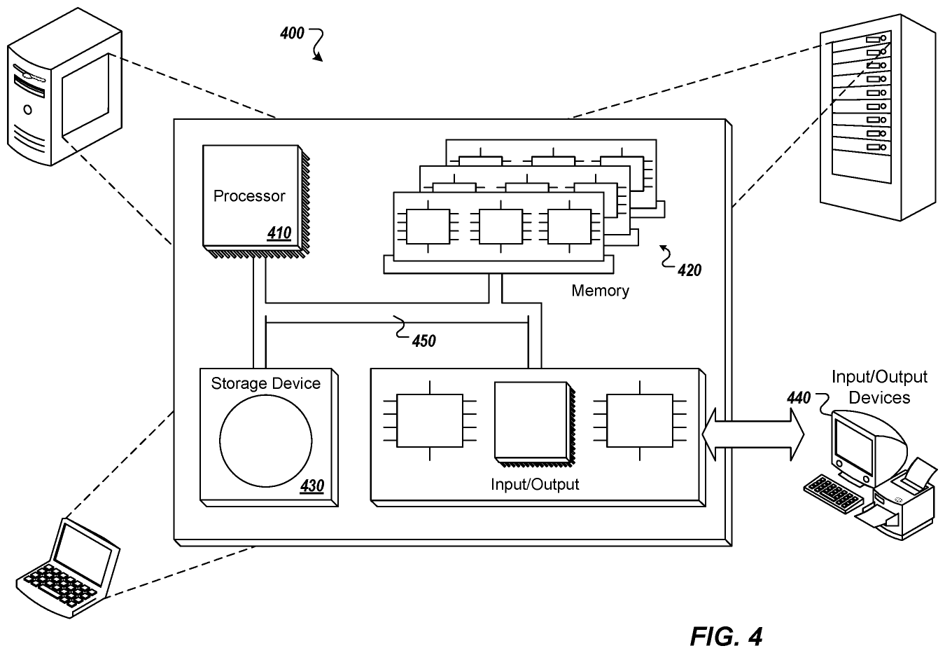

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for deploying machine learning (ML) models for inference in production environments, the method being executed by one or more processors and comprising:
providing a ML model using a set of training data, the ML model having a set of weights associated therewith;
generating a latent representation of the set of weights by inputting the set of weights into an encoder of a variational autoencoder (VAE);
generating a denoised latent representation based on conditioning text by:
diffusing the latent representation to generate a noisy latent representation, and
denoising the noisy latent representation to provide the denoised latent representation;
providing a reconstructed set of weights by inputting the denoised latent representation into a decoder of the VAE, the decoder outputting the reconstructed set of weights; and
deploying an updated ML model for production inference.

2. The method of claim 1, wherein the set of weights is provided as a weight matrix comprising weights that are generated for the ML model during training of the ML model.

3. The method of claim 1, wherein a dimension of the latent representation is less than a dimension of the set of weights.

4. The method of claim 1, wherein the conditioning text comprises a textual description of a condition that is one of absent from and underrepresented in the training data.

5. The method of claim 4, wherein the condition comprises one or more events associated with timeseries data, the one or more events comprising one or more of a spike and a cycle.

6. The method of claim 1, wherein deploying the ML model comprises transmitting the ML model to a production environment to receive timeseries data and generate inferences responsive to the timeseries data.

7. The method of claim 1, wherein the ML model is a long short-term memory autoencoder (LSTM-AE).

8. A non-transitory computer-readable storage medium coupled to one or more processors and having instructions stored thereon which, when executed by the one or more processors, cause the one or more processors to perform operations for deploying machine learning (ML) models for inference in production environments, the operations comprising:
providing a ML model using a set of training data, the ML model having a set of weights associated therewith;
generating a latent representation of the set of weights by inputting the set of weights into an encoder of a variational autoencoder (VAE);
generating a denoised latent representation based on conditioning text by:
diffusing the latent representation to generate a noisy latent representation, and
denoising the noisy latent representation to provide the denoised latent representation;
providing a reconstructed set of weights by inputting the denoised latent representation into a decoder of the VAE, the decoder outputting the reconstructed set of weights; and
deploying an updated ML model for production inference.

9. The non-transitory computer-readable storage medium of claim 8, wherein the set of weights is provided as a weight matrix comprising weights that are generated for the ML model during training of the ML model.

10. The non-transitory computer-readable storage medium of claim 8, wherein a dimension of the latent representation is less than a dimension of the set of weights.

11. The non-transitory computer-readable storage medium of claim 8, wherein the conditioning text comprises a textual description of a condition that is one of absent from and underrepresented in the training data.

12. The non-transitory computer-readable storage medium of claim 11, wherein the condition comprises one or more events associated with timeseries data, the one or more events comprising one or more of a spike and a cycle.

13. The non-transitory computer-readable storage medium of claim 8, wherein deploying the ML model comprises transmitting the ML model to a production environment to receive timeseries data and generate inferences responsive to the timeseries data.

14. The non-transitory computer-readable storage medium of claim 8, wherein the ML model is a long short-term memory autoencoder (LSTM-AE).

15. A system, comprising:
a computing device; and
a computer-readable storage device coupled to the computing device and having instructions stored thereon which, when executed by the computing device, cause the computing device to perform operations for deploying machine learning (ML) models for inference in production environments, the operations comprising:
providing a ML model using a set of training data, the ML model having a set of weights associated therewith;
generating a latent representation of the set of weights by inputting the set of weights into an encoder of a variational autoencoder (VAE);
generating a denoised latent representation based on conditioning text by:
diffusing the latent representation to generate a noisy latent representation, and
denoising the noisy latent representation to provide the denoised latent representation;
providing a reconstructed set of weights by inputting the denoised latent representation into a decoder of the VAE, the decoder outputting the reconstructed set of weights; and
deploying an updated ML model for production inference.

16. The system of claim 15, wherein the set of weights is provided as a weight matrix comprising weights that are generated for the ML model during training of the ML model.

17. The system of claim 15, wherein a dimension of the latent representation is less than a dimension of the set of weights.

18. The system of claim 15, wherein the conditioning text comprises a textual description of a condition that is one of absent from and underrepresented in the training data.

19. The system of claim 18, wherein the condition comprises one or more events associated with timeseries data, the one or more events comprising one or more of a spike and a cycle.

20. The system of claim 15, wherein deploying the ML model comprises transmitting the ML model to a production environment to receive timeseries data and generate inferences responsive to the timeseries data.
